(19) United States
(12) Patent Application Publication
(10) Pub. No.: US 2025/0185777 A1
(43) Pub. Date: Jun. 12, 2025

(54) DRYING APPARATUS

(71) Applicant: SZ ZUVI TECHNOLOGY CO., LTD., Shenzhen (CN)

(72) Inventors: Jianping HUANG, Shenzhen (CN); Mingyu WANG, Shenzhen (CN); Xingwang XU, Shenzhen (CN); Yin TANG, Shenzhen (CN); Tongyao HUANG, Shenzhen (CN)

(73) Assignee: SZ ZUVI TECHNOLOGY CO., LTD., Shenzhen (CN)

(21) Appl. No.: 19/006,125

(22) Filed: Dec. 30, 2024

Related U.S. Application Data
(63) Continuation of application No. PCT/CN2023/137956, filed on Dec. 11, 2023.

(51) Int. Cl. A45D 20/12

(52) U.S. Cl. CPC A45D 20/12

(57) ABSTRACT

A drying apparatus (10) comprises a housing (11), the housing (11) comprising a first air inlet (111), a second air inlet (112) and an air outlet (116) that are independent of each other, and the housing (11) is configured with a primary airflow channel, an auxiliary airflow channel, an airflow generating element (12) and a radiation element (13). An upstream of the primary airflow channel communicates with the first air inlet (111), and its downstream communicates with the air outlet (116); an upstream of the auxiliary airflow channel communicates with the first air inlet (111) and the second air inlet (112), and its downstream communicates with the primary airflow channel; the airflow generating element (12) is within the primary airflow channel and is configured to generate an airflow; and the radiation element (13) is at least partially within the auxiliary airflow channel and configured to generate infrared radiation.

### CROSS-REFERENCE TO RELATED APPLICATIONS

This application a Continuation application of International Application No. PCT/CN2023/137956, filed on Dec. 11, 2023, the entire contents of which are incorporated herein by reference.

### TECHNICAL FIELD

The present disclosure relates to the field of drying technology, in particular to a drying apparatus.

### BACKGROUND

A hair dryer comprises a heating element inside, which heat needs to be dissipated during operation. In the prior arts, the internal airflow channel of the hair dryer is generally designed so that part of the airflow passes through the heating element to dissipate heat. However, after long-time use of the hair dryer, foreign substances such as dust and hair will accumulate at the air inlet filter of the hair dryer. This may result in different degrees of blockage at the air inlet, causing the airflow entering the hair dryer to decrease. The corresponding airflow passing through the heating element will decrease as well, and there may be a problem of rising internal temperature of the hair dryer due to decreasing heat dissipation efficiency, bringing potential safety hazards.

### SUMMARY

The present disclosure provides a drying apparatus designed to solve the technical problem that the heat dissipation efficiency of the internal structure of the hair dryer in the prior arts will decrease during use.

The drying apparatus configured in the present disclosure comprises a housing, which comprises a first air inlet, a second air inlet and an air outlet that are independent of each other. The housing is configured with a primary airflow channel, an auxiliary airflow channel, an airflow generating element and a radiation element. Wherein an upstream of the primary airflow channel communicates with the first air inlet, and its downstream communicates with the air outlet; an upstream of the auxiliary airflow channel communicates with the first air inlet and the second air inlet, and its downstream communicates with the primary airflow channel. The airflow generating element is within the primary airflow channel And configured to generate an airflow. The radiation element is at least partially within the auxiliary airflow channel and configured to generate infrared radiation.

Additional aspects and advantages of the embodiment of this application will be given in part in the description below, and part will become apparent from the description below, or as known through the practice of this application.

### BRIEF DESCRIPTION OF THE DRAWINGS

The foregoing and/or additional aspects and advantages of the present disclosure will become apparent and readily understood from the detailed description of the embodiments in conjunction with the following accompanying drawings, wherein:

FIG. 1 is a schematic diagram of a structure of a drying apparatus and an airflow in some embodiments of the present disclosure;

FIG. 2 is a schematic diagram of a structure of a drying apparatus and an airflow in some other embodiments of the present disclosure;

FIG. 3 is a schematic diagram of A of FIG. 2 local enlarged;

FIG. 4 to FIG. 6 are schematic diagrams of a drying apparatus with local airflow in some embodiments of the present disclosure;

FIG. 7 is a schematic diagram of B of FIG. 6 local enlarged.

### DETAILED DESCRIPTION

The embodiments of the present disclosure are described in detail below, and examples of said embodiments are shown in the drawings wherein the same or similar designations denote the same or similar elements or elements having the same or similar functions throughout. The embodiments described below by reference to the drawings are illustrative and are intended to explain the embodiment of the present disclosure only and shall not be construed as a limitation on the embodiment of the present disclosure.

In the description of this disclosure, it is necessary to understand that the terms “center”, “longitudinal”, “horizontal”, “length”, “width”, “thickness”, “up”, “down”, “front”, “back”, “left”, “right”, “vertical”, “horizontal”, “top”, “bottom”, “inner”, “outside”, “clockwise”, “counterclockwise”, such orientation or positional relationship indicated is based on the orientation or positional relationship shown in the drawings, only for the convenience of describing the present disclosure and simplifying the description, and does not indicate or imply that the apparatus or element referred to must have such specific orientation, be constructed and operated in such particular orientation, and therefore may not be construed as a limitation on the present disclosure. In the description of this disclosure, “plurality” means two or more than two, unless otherwise expressly and specifically qualified.

In the description of the present disclosure, it is noted that, unless otherwise expressly specified or qualified, the terms “attached”, “connected”, “connected” are to be understood broadly, for example, they may be fixed, detachable, or integrally connected. It may be mechanically or electrically connected. It may be directly connected or indirectly connected through an intermediate medium, it may be the internal connection of two elements or the interaction relationship between two elements. For those of ordinary skill in the art, the specific meaning of the above terms in the present disclosure may be understood on a case-by-case basis.

In the present disclosure, unless otherwise expressly specified and qualified, the first feature “above” or “below” the second feature may include direct contact between the first and second features, or the first and second features are not in direct contact but through additional feature contact between them. Moreover, the first feature is “above”, “on”, and “over” the second feature includes the first feature directly above or obliquely above the second feature, or simply indicates that the first feature is horizontally higher than the second feature. The first feature is “below”, “beneath”, and “under” the second feature, including the first feature directly below and diagonally below the second feature, or simply indicating that the horizontal height of the first feature is less than that of the second feature.

The publication of this disclosure provides a number of different embodiments or examples to implement the different structures of the present disclosure. In order to simplify the disclosure of the present disclosure, the parts and settings for specific examples are described in this disclosure. They are only examples and are not intended to limit the present disclosure. In addition, the present disclosure may repeat the reference numbers and/or reference letters in different examples, and this repetition is for the purpose of simplification and clarity and does not in itself indicate the relationship between the various embodiments and/or settings in question. In addition, the present disclosure provides examples of various specific processes and materials, but those of ordinary skill in the art may be aware of the present disclosure of other processes and/or the use of other materials.

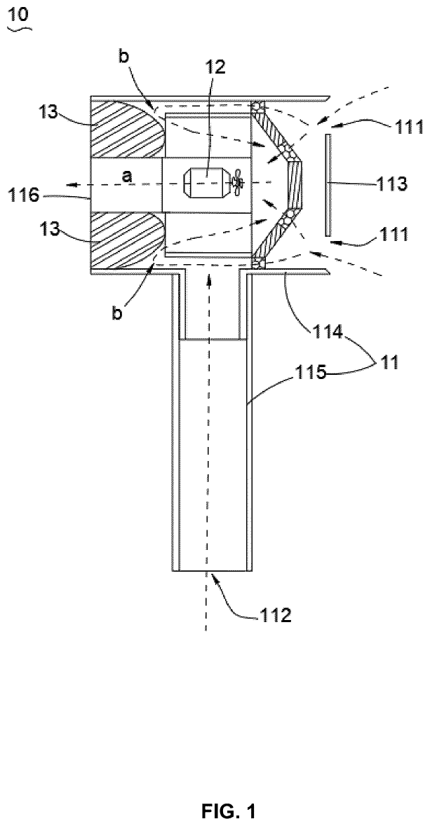

As shown in FIG. 1, some embodiments of the present disclosure provide a drying apparatus 10, comprising a housing 11 and an airflow generating element 12 and a radiation element 13 within the housing 11.

The housing 11 comprises an air outlet 116, a first air inlet 111 and a second air inlet 112 that are independent of each other. Mutual independence means that the first air inlet 111 and the second air inlet 112 are two different air inlets on the housing 11, and at least one of the following conditions shall be satisfied between them:

(1) The first air inlet 111 and the second air inlet 112 are configured on two different areas of the housing 11 and are spaced at a certain distance from each other.

(2) The airflows formed after the outside air enters the first air inlet 111 and the second air inlet 112 are independent of each other and will not merge near the first air inlet 111 and the second air inlet 112.

(3) When the first air inlet 111 and the second air inlet 112 inhale air from the outside, the air near either one will not be affected by the other.

(4) The flow path formed between the first air inlet 111 and the air outlet 116 is at least partially different from that formed between the second air inlet 112 and the air outlet 116.

A primary airflow channel A and an auxiliary airflow channel B are configured in the housing 11. An upstream of the primary airflow channel A communicates with the first air inlet 111, and its downstream communicates with the air outlet 116. An upstream of auxiliary airflow channel B communicates with the first air inlet 111 and the second air inlet 112 simultaneously, and its downstream communicates with the primary airflow channel A. The connectivity between two structures or areas in the present disclosure means that the airflow is able to flow freely between the two, either directly or indirectly. Direct connectivity means that the airflow leaves one structure or area and immediately enters another structure or area, while indirect connectivity means the interconnection between the two structures or areas is through other structures such as pipes, cavities, channels, etc., and the airflow leaves one structure or area, passes through other structures and then enters another structure or area. The following description deals with connectivity between other structures or regions, all of which refer to the ability of airflow to flow freely between two interconnected structures, either directly or indirectly, without repeating the explanation. In each accompanying drawing of the embodiment of the present disclosure, the airflow direction between the various areas inside the drying apparatus 10 during the operation of the airflow generating element 12 is indicated with a dashed arrow, and will not be repeated below.

The airflow generating element 12 is within the primary airflow channel A and configured to generate an airflow in the primary airflow channel A. The radiation element 13 is at least partially within the auxiliary airflow channel B. The airflow in the auxiliary airflow channel B is capable of dissipating heat of the radiation element 13 while it is operating.

When the airflow generating element 12 is operating, a negative pressure is directly formed in the primary airflow channel A. Since a downstream of the auxiliary airflow channel B communicates with a part of the primary airflow channel A which is an upstream end of the airflow generating element 12, the auxiliary airflow channel B is affected by the primary airflow channel A and also forms a negative pressure. Affected by the negative pressure of the primary airflow channel A and the auxiliary airflow channel B, the air in the external environment is sucked into the housing 11 via the first air inlet 111 and the second air inlet 112 to form an airflow, and the specific flow path is:

In the auxiliary airflow channel B: the air is inhaled via the first air inlet 111 and the second air inlet 112 to form an airflow. The airflow passes along the auxiliary airflow channel B, and passes through the radiation element 13 and dissipates its heat when flowing. The airflow from the auxiliary airflow channel B enters the primary airflow channel A.

In the primary airflow channel A: the air inhaled via the first air inlet 111, and enters the primary airflow channel A to form part of the airflow in the primary airflow channel A. The airflow from the auxiliary airflow channel B enters the primary airflow channel A and forms another part of the airflow in the primary airflow channel A. The airflow in the primary airflow channel A emits from the drying apparatus 10 via the air outlet 116 and dry an object. In some specific embodiments, most of the airflow in the primary airflow channel A comes from the air directly inhaled via the first air inlet 111, and a small part of the airflow comes from the auxiliary airflow channel B. In some other specific embodiments, a small part of the airflow in the primary airflow channel A comes from the air directly inhaled via the first air inlet 111, and most of the airflow comes from the auxiliary airflow channel B. In other embodiments, half of the airflow in the primary airflow channel A comes from the air directly inhaled via the first air inlet 111, and the other half comes from the auxiliary airflow channel B.

The radiation element 13 generates infrared radiation (IR) with a preset wavelength range and power density during operation, and directly heats the moisture of the target after emitting to a target (such as hair, fabric). Almost no heat is absorbed by the surrounding air in radiation heat transfer, and the energy utilization rate is greatly improved compared with traditional heat conduction. When the radiation element 13 and the airflow generating element 12 operate simultaneously, the airflow together with infrared radiation accelerates water evaporation of the target.

The operation principle of the radiation element 13 is based on blackbody radiation, which radiates in the range from infrared to visible light in the form of heat transfer. Blackbody radiation is broadband radiation, and the central wavelength as well as the spectral bandwidth decreases as the temperature increases. The total energy radiated by a blackbody is proportional to S×T4, where S is the surface area and T is the temperature.

The radiation element 13 needs to operate within a suitable temperature range. If the temperature of the radiation element 13 is too high during operation, the central wavelength will decrease, and the infrared radiation emitted shall deviate from the preset wavelength. As a result, the drying efficiency will be affected. Moreover, the radiation element 13 at high-temperature may also heat its adjacent parts and the housing 11, and easily increase the overall temperature of the drying apparatus 10 to be very high. If the temperature of the radiation element 13 is too low during operation, it needs to convert more electrical energy into heat energy to maintain its operating temperature and emit infrared radiation of a preset wavelength, resulting in a waste of electrical energy. Therefore, when designing the relevant structure in the drying apparatus 10, it is necessary to comprehensively consider the heat dissipation area, heat dissipation demand, heat dissipation airflow rate, heat dissipation airflow speed and other factors on the radiation element 13, to ensure that the radiation element 13 always operates within a suitable temperature range.

The traditional hair dryer is equipped with an airflow channel inside for heat dissipation, and part of the airflow is channeled into the heat dissipation airflow channel to dissipate heat of the electrical components such as main control circuit, power supply circuit, motor, and motor control circuit. These electrical components are able to withstand a wide range of temperatures and are insensitive to changes of airflow in the heat dissipation airflow channel. However, the radiation element 13 may adapt to a small range of temperature range during operation, and the problems of central wavelength and spectral bandwidth change are easy to occur after temperature rises. The service life of the radiation element 13 as a result may decrease. Therefore, the radiation elements 13 are more sensitive to changes in the heat dissipation airflow than other electrical components.

The drying apparatus 10 in the embodiment of the present disclosure is at least partially configured in the auxiliary airflow channel B. The auxiliary airflow channel B may simultaneously draw air via the first air inlet 111 and the second air inlet 112 that are independent of each other to form an airflow and dissipate heat of the radiation element 13.

When both the first air inlet 111 and the second air inlet 112 are completely unblocked (e.g., a brand-new drying apparatus 10 that has not been used), assume that the total airflow rate S1 in the auxiliary airflow channel B is a1+b1, wherein a1 is the airflow rate of the airflow entering the auxiliary airflow channel B via the first air inlet 111, and b1 is the airflow rate of the airflow entering the auxiliary airflow channel B via the second air inlet 112.

When the first air inlet 111 is blocked, the total airflow rate of the airflow in the auxiliary airflow channel B is S2=a2+b2. Wherein a2 is the airflow rate of the airflow entering the auxiliary airflow channel B via the first air inlet 111, and b2 is the airflow rate of the airflow entering the auxiliary airflow channel B via the second air inlet 112. Because the airflow rate of the airflow entering the auxiliary airflow channel B via the first air inlet 111 decreases, i.e., a2<a1, due to negative pressure in the primary airflow channel A, the airflow rate of the airflow entering the auxiliary airflow channel B via the second air inlet 112 increases, i.e., b2>b1. Thus, S2≤S1, and (S1−S2)<(a1−a2). In other words, when the first air inlet 111 is blocked and the airflow rate of the airflow passing through it decreases, the airflow rate of the airflow via the second air inlet 112 shall increases, so that the reduced airflow rate of the airflow in the auxiliary air inlet B is smaller than the reduced airflow rate of the airflow passing through the first air inlet 111, thereby alleviating the loss of heat dissipation efficiency of the radiation element 13 caused by the blockage of the first air inlet 111.

In the same way, when the second air inlet 112 is blocked, the airflow rate of the airflow entering via the first air inlet 112 will also increase accordingly, and the above process may also be referred to.

During operation of the drying apparatus 10 in the above-mentioned embodiment, when one of the first air inlet 111 and the second air inlet 112 is blocked and causes airflow entering it to decrease, the auxiliary airflow channel B may inhale more airflow from the other to make up for the reduced airflow rate due to the blockage, so that the airflow in the auxiliary airflow channel B may maintain a dynamic balance, and the heat dissipation efficiency of the radiation element 13 is satisfied.

For example, when using a drying apparatus 10, the following may occur:

(1) The user mis-operates the drying apparatus 10 and causes a foreign object to block one of the first air inlet 111 and the second air inlet 112. For example, when grasping the drying apparatus 10, the palm is positioned at the first air inlet 111 and as a result it covering it. Alternatively, when using the drying apparatus 10, the cloth, hair and other articles may be moved by negative pressure and then tightly attached to the first air inlet 111 to cover it. In such working conditions, if the auxiliary airflow channel B only inhales air via the first air inlet 111, it may cause airflow rate inside to drop rapidly, and the radiation element 13 may not effectively dissipate its heat and its temperature may go up rapidly, thereby causing a danger of overheating. By operating the drying apparatus 10 in the embodiment of the present disclosure, after the first air inlet 111 is blocked, the airflow rate of the airflow entering the auxiliary airflow channel B via the second air inlet 112 may rise immediately, and the radiation element 13 may continue to effectively dissipate its heat to avoid the danger of overheating.

(2) When the user operates the drying apparatus 10 for a long time, it may be blocked by more and more foreign objects at the first air inlet 111, so that its airflow rate may gradually decrease. When the degree of blockage at the first air inlet 111 of the drying apparatus 10 is low, the user is difficult to sense the change of airflow rate of the output airflow from the drying apparatus 10, and may not actively clean the first air inlet 111. If the auxiliary airflow channel B only inhales air via the first air inlet 111, the heat dissipation efficiency of the radiation element 13 may be affected. This may not only accelerate the life loss rate of the radiation element 13, but also eventually cause a danger of overheating. When the degree of blockage at the first air inlet 111 of the drying apparatus 10 in the embodiment of the present disclosure gradually increases due to accumulation of debris, the airflow rate of the airflow entering the auxiliary airflow channel B via the second air inlet 112 may also gradually increase, so that the airflow flow in the auxiliary airflow channel B maintains a dynamic balance to effectively dissipate heat of the radiation element 13 during long-term use of the drying apparatus 10 by the user, which may increase the service life of the radiation element 13 and the drying apparatus 10.

In some embodiments shown in FIG. 1, the housing 11 may comprises a main body 114 and a handle 115. The main body 114 may comprise an air outlet 116 and a first air inlet 111. The primary airflow channel A and at least part of the auxiliary airflow channel B are configured in the main body 114. The airflow generating element 12 and the radiation element 13 are configured in the main body 114. The handle 115 may comprise a second air inlet 112 configured on the main body 114. The handle 115 is configured to allow the user to operate the entire drying apparatus 10 hand-held.

The handle 115 and the main body 114 are two independent parts. The first air inlet 111 is configured on the main body 114, and the second air inlet 112 is configured on the handle 115, so that the first air inlet 111 and the second air inlet 112 are relatively far away in distance, making it uneasy to block or obscure both at the same time. Moreover, when one of the first air inlets 111 and the second air inlets 112 inhales the airflow from the outside, it does not affect the other inhaling the airflow from the outside.

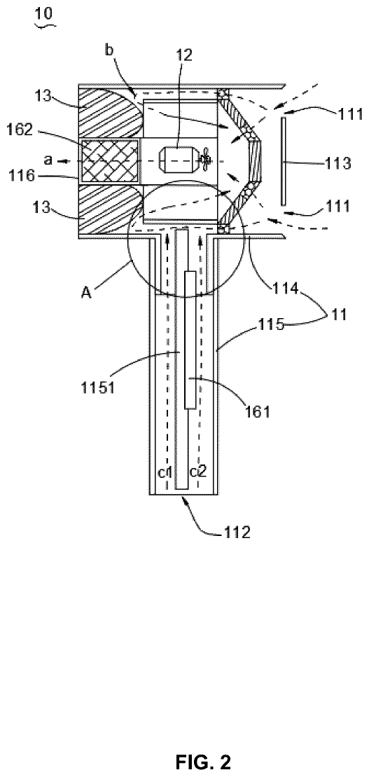

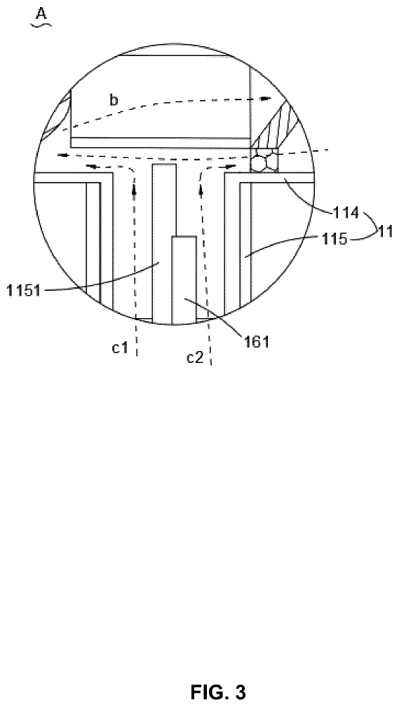

In some embodiments shown in FIG. 2 and FIG. 3, the handle 115 is configured with a first sub airflow channel C1, a second sub airflow channel C2 and a first heating element 161. An upstream of the first sub airflow channel C1 communicates with the second air inlet 112, and its downstream communicates with the upstream of the auxiliary airflow channel B. An upstream of the second sub airflow channel C2 communicates with the second air inlet 112, and its downstream communicates with the upstream of the primary airflow channel A. The first heating element 161 is partially configure in the second sub airflow channel C2.

The airflow entering the handle 115 via the second air inlet 112, part of which passes along the first sub airflow channel C1, flows out of the first sub airflow channel C1 and then merges to form an airflow via the second air inlet 112 in the auxiliary airflow channel B. The other part passes along the second sub airflow channel C2, passes through the first heating element 161 to dissipate its heat, flows out of the second sub airflow channel C2 and merges at the upstream of the primary airflow channel A.

The differences between the first sub airflow channel C1 and the second sub airflow channel C2 are:

(1) The airflow rate is different. The airflow in the first sub airflow channel C1 does not pass through the first heating element 16 while the airflow in the second sub airflow channel C2 passes through the first heating element 161. Therefore, the airflow resistance in the first sub airflow channel C1 is smaller than that in the second sub airflow channel C2. Correspondingly, the airflow rate in the first sub airflow channel C1 is greater than that in the second sub airflow channel C2. In other words, most of the airflow entering the handle 115 from the second sub airflow channel C2 merges into the auxiliary airflow channel B along the first sub airflow channel C1 to dissipate heat of the radiation element 13. A small part passes along the second sub airflow channel C2 to dissipate heat of the first heating element 161. When the first air inlet 111 is blocked, the airflow rate in the auxiliary airflow channel B may be smoothly supplemented by airflow passing along the first sub airflow channel C1 with less airflow resistance, so as to maintain the heat dissipation efficiency of the radiation element 13.

(2) The airflow temperature is different. The airflow in the second sub airflow channel C2 is heated by the first heating element 161 after passing through it. The airflow temperature in the second sub airflow channel C2, therefore, is higher than that in the first sub airflow channel C1. If the airflow in the second sub airflow channel C2 merges into the auxiliary airflow channel B, the airflow temperature in the auxiliary airflow channel B will rise. The temperature difference is one of the main factors affecting the heat dissipation efficiency. When the temperature of the airflow in the auxiliary airflow channel B increase, the temperature difference between it and the radiation element 13 decreases, which may reduce the heat dissipation efficiency of the radiation element 13. Therefore, the airflow in the first sub airflow channel C1 in the handle 115 is merged into the auxiliary airflow channel B, and the airflow in the second sub airflow channel C2 is merged into the primary airflow channel A, which may not only dissipate heat of the first heating element 161 in the handle 115, but also prevent the heat dissipation efficiency of the radiation element 13 from decreasing after the airflow is heated.

(3) The negative pressure inside is different. Since the airflow resistance in the first sub airflow channel C1 is less than that of the second sub airflow channel C2, if the negative pressure received by both are the same, almost all the airflow entering via the second air inlet 112 will enter the first sub airflow channel C1, with only a weak airflow in the second sub airflow channel C2, which makes it difficult to effectively dissipate heat of the first heating element 161. Therefore, the downstream of the first sub airflow channel C1 communicates with the auxiliary airflow channel B, and the downstream of the second sub airflow channel C2 communicates with the primary airflow channel A. If the negative pressure received in the primary airflow channel A is greater than that in the auxiliary airflow channel B, the negative pressure of the second sub airflow channel C2 will be greater than that of the first sub airflow channel C1, ensuring that sufficient airflow may exist in the second sub airflow channel C2 to meet the heat dissipation demand of the first heating element 161.

As shown in FIG. 2 and FIG. 3, in some more specific embodiments, the drying apparatus 10 further comprises a substrate 1151. At least part of the substrate 1151 is within the handle 115. The first sub airflow channel C1 and the second sub airflow channel C2 are respectively configured on two sides of the substrate 1151. A plurality of electronic components is configured on one side of the substrate 1151 facing the second sub airflow channel C2, and constitutes a first heating element 161.

While the drying apparatus 10 is operating, the plurality of electronic components consumes electricity and generates heat. These electronic components are configured in the second sub airflow channel C2 and dissipate heat by the airflow in the second sub airflow channel C2. In addition, the substrate 1151 is a plate-like structure, which divides the handle 115 into the first sub airflow channel C1 and the second sub airflow channel C2. The first sub airflow channel C1 is configured along one side of the substrate 1151 without electronic components, and therefore having a low airflow resistance. In some more specific embodiments, part of the heat of the plurality of electrical components is transmitted to the substrate 1151, and the airflow in the first sub airflow channel C1 dissipates the heat of the substrate 1151, thereby indirectly assisting the heat dissipation of the plurality of electronic components (i.e., the first heating element 161).

In a more specific embodiment, the substrate 1151 may be a printed circuit board (PCB), a flexible circuit board and other structures. The plurality of electronic components is configured on the substrate 1151 in an integrated or soldering manner to form at least a partial control circuit and/or power supply circuit of the drying apparatus 10.

In other specific embodiments, the substrate 1151 is the motherboard of a battery management system (BMS), which may provide functions such as power supply, communication, charge and discharge management. A battery module is coupled to and configured on the substrate 1151, which comprises one or more cells. The battery module and/or related components on the substrate 1151 constitute a first heating element 161. The battery module of the drying apparatus 10 may store electricity for unlimited use. The battery module may generate heat during charging or discharging, which heat (i.e., the first heating element 161) and/or that of the substrate 1151 are dissipated by the airflow in the second sub airflow channel C2.

Referring to FIG. 2 and FIG. 3, in some specific embodiments, a plane where the substrate 1151 is located is perpendicular to the airflow direction of the primary airflow channel A. The first sub airflow channel C1 and the second sub airflow channel C2 are configured side by side on both sides of it along the airflow direction of the primary airflow channel A. In other embodiments, the plane where the substrate 1151 is located may also be parallel to the airflow direction of the primary airflow channel A, or have a certain angle.

In other embodiments not shown, the handle 115 comprises two relatively independent chambers, which forms the first sub airflow channel C1 and the second sub airflow channel C2 respectively. The first heating element 161 and/or the substrate 1151 are configured in the chamber corresponding to the second sub airflow channel C2. In this way, the airflow in the first sub airflow channel C1 does no contact the substrate 1151 and may be merged into the auxiliary airflow channel B at a temperature similar to that when entering the handle 115.

In some embodiments as shown in FIG. 2 and FIG. 3, a portion of the substrate 1151 is within the handle 115, and the other part extends into the main body 114. Since the auxiliary airflow channel B and the primary airflow channel A are both in the main body 114, the airflow direction of the first sub airflow channel C1 and the second sub airflow channel C2 is from the handle 115 to the main body 114. When the airflow in the first sub airflow channel C1 and the second sub airflow channel C2 flows from the handle 115 and into the main body 114, it is guided by the substrate 1151 extending into the main body 114, so that it enters the main body 114 along the preset airflow direction and remain in a relatively separate state after entering the main body 114. In other embodiments, the entire substrate 1151 may be within the handle 115. Then the airflow in the first sub airflow channel C1 and the second sub airflow channel C2 enters the main body 114 and merges, and flows to the auxiliary airflow channel B and the primary airflow channel A respectively under the influence of negative pressure. In other embodiments, the entire substrate 1151 may be within the handle 115, and a guiding structure is configured at a corresponding position in the main body 114, so that the airflow in the first sub airflow channel C1 and the second sub airflow channel C2 remains in a relatively separated state after entering the main body 114, and passes along a preset direction.

In some embodiments as shown in FIG. 2 and FIG. 3, along the airflow direction of primary airflow channel A, the second sub airflow channel C2 and the first sub airflow channel C1 are configured side by side. The second sub airflow channel C2 is located closer to the first air inlet 111, and the airflow from the second sub airflow channel C2 flows near the first air inlet 111 and finally merges into the primary airflow channel A. The first sub airflow channel C1 is located closer to the radiation element 13, and the airflow from the first sub airflow channel C1 directly enters the auxiliary airflow channel B to dissipate heat of the radiation element 13.

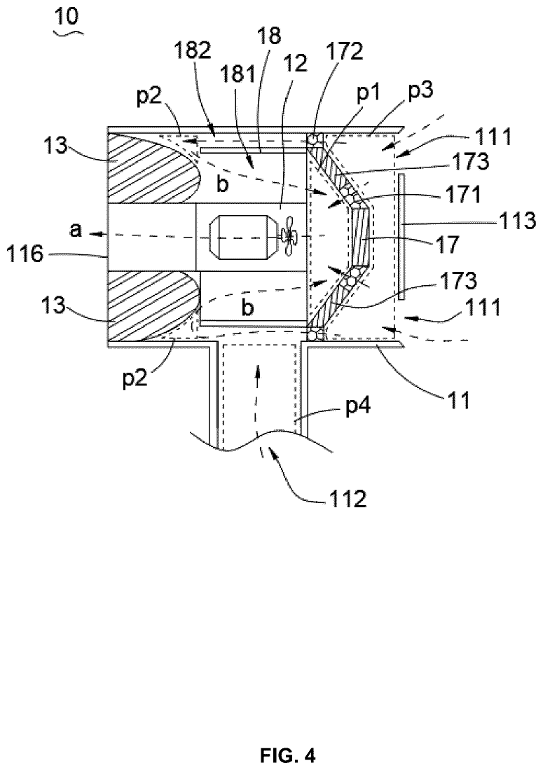

In some embodiments shown in FIG. 4, the drying apparatus 10 further comprises an airflow guide 17 configured inside the first air inlet 111, and the airflow guide 17 constitutes a first vent 171 and a second vent 172. The upstream of the primary airflow channel A communicates with the first air inlet 111 via the first vent 171, and the upstream of the auxiliary airflow channel B communicates with the first air inlet 111 via the second vent 172. The airflow entering the housing 11 via the first air inlet 111 is divided into two parts at the airflow guide 17, one part of which enters the upstream of the primary airflow channel A along the first vent 171, and the other part enters the upstream of the auxiliary airflow channel B along the second vent 172.

The negative pressure inside the primary airflow channel A is larger while the negative pressure in the auxiliary airflow channel B is smaller. If the upstream of both communicates directly with the first air inlet 111, most of the airflow will enter the primary airflow channel A, and there will be only a weak airflow in the auxiliary airflow channel B. which makes it difficult to meet the heat dissipation demand of the radiation element 13. After the airflow guide 17 is configured at the first air inlet 111, the airflow passing through the airflow guide 17 is divided into two part so that the airflow via the first vent 171 and the second vent 172 passes through the airflow guide 17 and enters the corresponding airflow channel respectively. Thereby too little airflow in the auxiliary airflow channel B may be avoided. Moreover, by adjusting the areas of the first vent 171 and the second vent 172, the airflow rate of the airflow entering the primary airflow channel A and the auxiliary airflow channel B may be controlled respectively, so that the airflow flow in the auxiliary airflow channel B satisfies the heat dissipation demand of the radiation element 13.

In some embodiments, a complete first vent 171 and a second vent 172 are configured on the airflow guide 17. In other embodiments, at least one of the first vent 171 and the second vent 172 is formed by the airflow guide 17 together with other structures (such as the housing 11 or a structure configured in the housing 11).

As shown in FIG. 4, a negative pressure may be formed inside the drying apparatus 10 during operation of the airflow generating element 12, which location may become the area with the largest negative pressure in the entire drying apparatus 10. The air in the external environment of the drying apparatus 10 may flow freely, which negative pressure is considered to be zero. Therefore, the air in the external environment of the drying apparatus 10 may be affected by negative pressure and enter via the first air inlet 111 and the second air inlet 112, and flow towards the airflow generating element 12 along a preset airflow channel in the housing 11.

Specifically, when the airflow generating element 12 is operating, the first region P1, the second region P2, the third region P3 and the fourth region P4 are configured in the housing 11 with decreasing negative pressures sequentially. It shall be noted that the division of the above four regions is only for the convenience of describing the airflow in the housing 11, and it is not limited to only these four regions in the housing 11. In addition, for ease of understanding, the areas in the diagram are indicated by dotted boxes, but the dotted boxes do not define the boundaries of each region, and each region itself may not have specific and clear boundaries.

The first region P1 is configured between the airflow guide 17 and the airflow generating element 12. The airflow generating element 12 directly forms negative pressure in the first region P1, so that the first region P1 is the region with the largest negative pressure among the four regions. The airflow in the other regions has a tendency to flow to the first region P1.

The second region P2 is adjacent to the radiation element 13, and the second region P2 is in communication with the first region P1, the third region P3, and the fourth region P4 respectively. Affected by the negative pressure in the first region P1, a negative pressure lower than that in the first region P1 is formed in the second region P2. The airflow in the second region P2 then has a tendency to flow to the first region P1.

The third region P3 is adjacent to and in communication with the first air inlet 111. The third region P3 communicates with the first region P1 via the first vent 171 and the second region P2 via the second vent 172. The airflow in the third region P3 has a tendency to flow to the first region P1 and the second region P2.

The fourth region P4 is adjacent to and in communication with the second air inlet 112.

The third region P3 and the fourth region P4 are respectively in communication with the external environment with zero negative pressure, and become the two regions with the smallest negative pressure. Since the third region P3 is in direct communication with the first region P1 via the first vent 171, and the fourth region P4 is in indirect communication with the first region P1 via the second region P2, the airflow channel from the third region P3 to the first region P1 is shorter, and the airflow channel from the fourth region P4 to the first region P1 is longer. The negative pressure in the third region P3 is then greater than that in the fourth region P4.

When the first air inlet 111 and the second air inlet 112 are completely unblocked, the airflow direction in the housing 11 is roughly as follows:

(1) The airflow via the first air inlet 111 is divided into two parts after entering the third region P3:

The first part flows into the first region P1 via the first vent 171, passes through the airflow generating element 12 and then passes along the primary airflow channel A before leaving the drying apparatus 10 (all the airflow after entering the first region P1 passes along this channel, which will not be repeated subsequently). This part of the airflow constitutes the main airflow in the primary airflow channel A (the airflow of the auxiliary airflow channel B constitutes the secondary airflow in the primary airflow channel A), and its airflow channel is the shortest, and its airflow rate is the largest with the smallest airflow noise, which may ensure that the output airflow of the primary airflow channel A is of smoothness, at low noise and high airflow speed.

The second part of the airflow flows into the second region P2 via the second vent 172, and exchanges heat with the radiation element 13 when passing along the auxiliary airflow channel B, and flows from the auxiliary airflow channel B into the first region P1. This part of the airflow constitutes the main airflow in the auxiliary airflow channel B, on which the heat dissipation of the radiation element 13 mainly depends.

(2) The airflow via the second air inlet 112 enters the fourth region P4, flows to the second region P2, and then passes along the auxiliary air channel B. When the first air inlet 111 and the second air inlet 112 are completely unblocked, the airflow rate is relatively small because the airflow channel of this part of the airflow is longer, which constitutes the secondary airflow in the auxiliary airflow channel B and dissipates heat of the radiation element 13.

When the first air inlet 111 is blocked and the second air inlet 112 is unblocked, the general change process of the airflow in the auxiliary airflow channel A is as follows:

The overall airflow in the third region P3 decreases, and the airflow from the third region P3 to the first region P1 and the second region P2 decreases, resulting in an increase of the negative pressure in the first region P1, which in turn leads to the increase of negative pressure in both the second region P2 and the fourth region P4. The airflow rate of the airflow in the fourth region P4 inhaled via the second air inlet 112 increases, and the airflow rate from the fourth region P4 to the second region P2 also increases, making up for the reduced part of the airflow from the third region P3 in the auxiliary airflow channel B, so as to maintain the heat dissipation effect of the radiation element 13.

Similarly, when the second air inlet 112 is blocked, the airflow from the third region P3 to the second region P2 increases, and the airflow volume in the auxiliary airflow channel B may be maintained. In this way, the airflow in the second region P2 may be in a dynamic equilibrium, and the heat dissipation needs of the radiation element 13 may always be satisfied.

In some embodiments, the airflow of the fourth region P4 all enters the second region P2, that is, the air entering via the second air inlet 112 all merges into the auxiliary airflow channel B.

In other embodiments, part of the airflow in the fourth region P4 enters the second region P2, and the other part of the airflow enters the third region P3 via the second vent 172, thereby becoming part of the airflow in the third region P3. The airflow direction in the third region P3 refers to the above process. That is, one part of the air entering via the second air inlet 112 merges into the auxiliary airflow channel B, and another part of it merges into the primary airflow channel A.

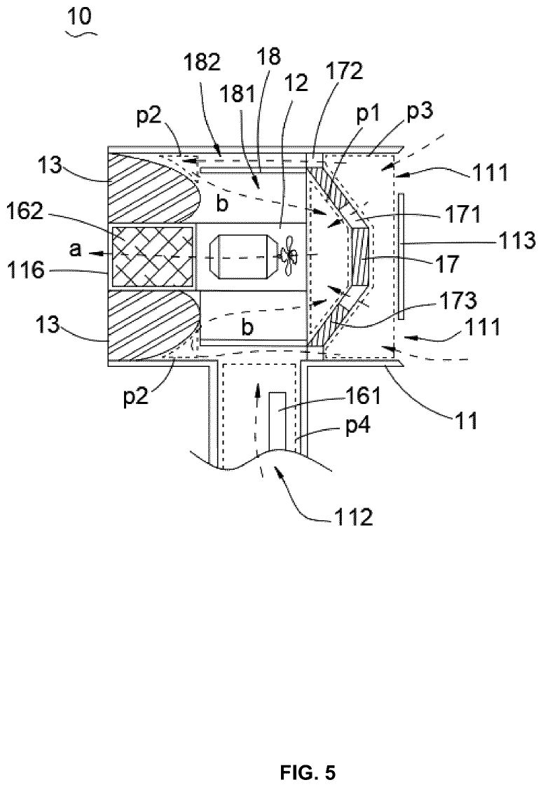

As shown in FIG. 5, in some more specific embodiments, the fourth region P4 is also configured with a first heating element 161. The distance between the first heating element 161 and the third region P3 is smaller than the distance between the first heating element 161 and the second region P2. When the airflow passes through the fourth region P4, since the first heating element 161 is in proximity to the third region P3, the airflow from the fourth region P4 to the third region P3 will pass through the first heating element 161 and dissipate heat. The airflow from the fourth region P4 to the second region P2 hardly passes through the first heating element 161 and remains at room temperature while merging into the auxiliary airflow channel B. The heat dissipation to the first heating element 161 may be referred to relevant content above.

In some embodiments shown in FIG. 4, an air guiding sleeve 18 is configured in the housing 11, and the airflow generating element 12 is positioned inside the air guiding sleeve 18. A first gap airflow channel 181 is configured between the airflow generating element 12 and the air guiding sleeve 18 for the airflow to pass through. The first region P1 communicates with the second region P2 via the first gap airflow channel 181. A second gap airflow channel 182 is configured between the air guiding sleeve 18 and the housing 11 through which the airflow may pass. One end of the second gap airflow channel 182 communicates with the second region P2 while the other end communicates with the third region P3 via the second vent 172. Its middle part communicates with the fourth region P4.

The first gap airflow channel 181 and the second gap airflow channel 182 are not limited to airflow channels with specific shapes and boundaries formed by related structures above. They may also be formed by reserving a plurality of discontinuous gaps on a plurality of related structures. According to the negative pressure relationship of the above-mentioned regions, as long as an airflow may be formed between the relevant regions, the first gap airflow channel 181 and the second gap airflow channel 182 are formed.

In some more specific embodiments, one end of the air guiding sleeve 18 is coupled to the airflow guide 17 and forms a seal, which isolates the first gap airflow channel 181 from the second gap airflow channel 182. The other end of the air guiding sleeve 18 is coupled to the radiation element 13 to form at least part of the second region P2 at the coupling location. The first gap airflow channel 181 communicates with the second gap airflow channel 182 via the second region P2.

Correspondingly, the airflow direction in the auxiliary airflow channel B is as follows: first, it passes through the second gap airflow channel 182, enters the second region P2 and dissipates heat from the radiation element 13, and then it passes through the first gap airflow channel 181 and merges into the first region P1. The airflow in the second gap airflow channel 182 is a normal temperature airflow, and may also dissipate heat from the housing 11 when flowing.

In some embodiments shown in FIG. 4, the airflow guide 17 is configured with a mounting portion (not shown), which is configured for coupling to the air guiding sleeve 18. The air guiding sleeve 18 itself is directly or indirectly coupled to the housing 11. The airflow guide 17 is configured on the air guiding sleeve 18, thereby indirectly coupled to the housing 11. In the radial direction of the airflow guide 17, the second vent 172 is located outside the mounting portion, and the first vent 171 is located inside the mounting portion. The first vent 171 and the second vent 172 may be a plurality of through holes, grids, hollow structures, etc., which are configured at the corresponding positions on the airflow guide 17.

Since the second vent 172 is located outside the mounting portion, the airflow via the second vent 172 passes along the outer wall of the air guiding sleeve 18 (i.e., along the second gap airflow channel 182). Similarly, the first vent 171 is located inside the mounting portion, and the airflow via the first vent 171 passes along the inner wall of the air guiding sleeve 18 (i.e., along the first gap airflow channel 181).

In some other embodiments not shown, the outer edge of the airflow guide 17 forms a mounting portion for coupling to the housing 11. At least part of the second vent 172 is configured on the mounting portion. That is, the airflow guide 17 is not coupled to the air guiding sleeve 18, but is directly coupled to the housing 11. The airflow via the second vent 172 passes along the inner wall of the housing 11 (i.e., along the second gap airflow channel 182). The second vent 172 may be a plurality of through holes, grille structures, hollow structures, etc., which are configured on the mounting portions.

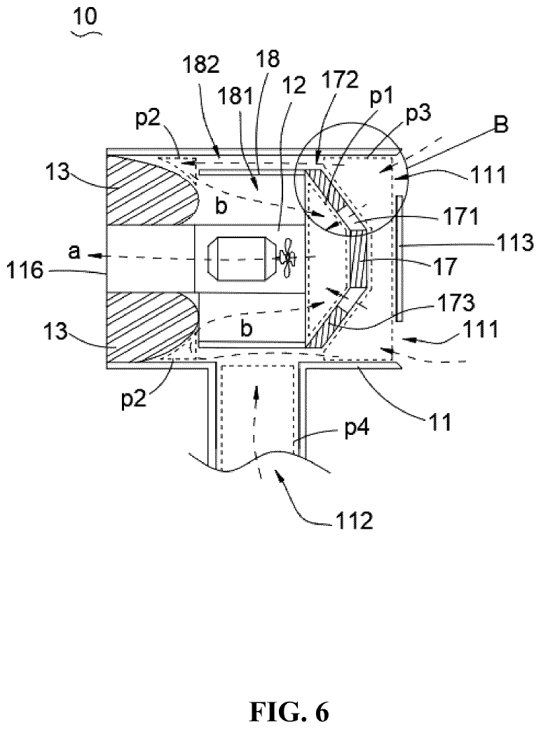

In some embodiments shown in FIG. 6, the gap between the outer edge of the airflow guide 17 and the housing 11 constitutes a second vent 172. That is, the airflow guide 17 forms part of the second vent 172 while the housing 11 forms another part of the second vent 172. Then, there are no through holes, grids or hollow structures configured on the airflow guide 17 corresponding to the second vent 172.

In some embodiments shown in FIG. 4, the second vent 172 is configured around the outside of the first vent 171. Because the airflow generating element 12 is configured at the axis position of the housing 11, configuring the first vent 171 inside the radial direction of the airflow guide 17, can reduce the flow path of the airflow entering the primary airflow channel A via the first vent 171 and increases the airflow volume and airflow speed of the primary airflow channel A as much as possible.

In some specific embodiments, the first vent 171 is circular or annular and the second vent 172 is annular and coincides with the geometric center of the first vent 171. The geometric center of the two is roughly located on the axis of the housing 11. When the airflow generating element 12 is operating, a negative pressure area is formed along the axis of the housing 11, so that the primary airflow channel A and the auxiliary airflow channel B may form a uniform and stable airflow in the radial direction.

In some embodiments shown in FIG. 4, the airflow guide 17 is also configured with an air guide 173 connected between the first vent 171 and the second vent 172. The airflow flowing to the airflow guide 17 may be roughly divided into three parts. The first part is configured at the first vent 171 and may directly pass through the first vent 171. The second part is configured at the second vent 172 and may directly pass through the second vent 172. The third part is configured at the air guide 173 and passes along the air guide 173 and is guided to one of the first vent 171 and the second vent 172.

In some more specific embodiments, the first vent 171, the air guide 173, and the second vent 172 are all annular and nested in sequence. The airflow flowing to the air guide 173 may be guided to the second vent 172 on its outer edge or to the first vent 171 on its inner edge. The airflow flowing to the first vent 171 and the second vent 172 flows into the corresponding airflow channel in an annular and radially uniform manner.

In some more specific embodiments, the air guide 173 is configured to be inclined relative to the airflow direction of the primary airflow channel A. The airflow sucked in via the first air inlet 111 under the influence of negative pressure in the primary airflow channel A will flow in a direction towards the primary airflow channel A. When it passes through the air guide 173, it is guided and its direction is changed towards the first vent 171 or the second vent 172. Because the air guide 173 is configured to be inclined, it forms an angle with the airflow before being guided instead of perpendicular to each other, which may reduce the airflow noise and turbulence during the airflow guiding process and make the airflow smoother.

In some embodiments shown in FIG. 4, the airflow guide 17 comprises a side wall inclined relative to the airflow direction of the primary airflow channel A. The air guide 173 and the first vent 171 are all formed on the inclined side wall. That is, the air guide 173 and the first vent 171 are all inclined to adapt to the airflow whose direction points to the primary airflow channel A.

In some more specific embodiments, the first vent 171 comprises a plurality of ventilation holes, and the axis of at least part of the ventilation holes is inclined relative to the airflow direction of the primary airflow channel A. In some other specific embodiments, the first vent 171 comprises a hollow structure, whose side wall is inclined to the airflow direction of the primary airflow channel A.

In some more specific embodiments, a plurality of vents is distributed in a circular manner, with at least some of the axes of the vents intersecting at the airflow generating element 12. When the airflow passes through each ventilation hole, it passes along its inclined axis, directs the airflow in a radial direction and converges at the airflow generating element 12, so that the airflow in the region smoothly enters the primary airflow channel A, and the airflow noise and airflow resistance are kept low.

In some more specific embodiments, the first vent 171 comprises a grid, which comprises a plurality of supporting strips extending radially and/or circumferentially along the airflow guide 17. Each supporting strip forms an inclined surface with low airflow resistance in the direction of the first air inlet 111. The plurality of supporting strips encloses to form a plurality of ventilation holes. Because each supporting strip comprises an inclined surface with low airflow resistance, the airflow resistance is small when the airflow passes through the first vent 171, and the airflow noise is also small.

In some specific embodiments, the middle part of the airflow guide 17 is convex in a direction away from the airflow generating element 12, and a recess is formed on one side facing the airflow generating element 12. The recess forms at least a partial boundary of the first region P1. According to the foregoing, the airflow in the auxiliary airflow channel B merges into the first region P1, that is, it flows into the recess of the airflow guide 17, mixes with the airflow from the first vent 171, and enters the primary airflow channel A.

In some more specific embodiments, the shape of the airflow guide 17 may be any one of a bevel, a truncated cone, a pyramid, a cone, with a larger bottom, a smaller top, and an inclined side walls. The aforesaid first vent 171 and the air guide 173 are configured on the side walls to act as the air inlet and air guide in an inclined state. The relevant technical effects may refer to the foregoing. The bottom faces the airflow generating element 12 and the top faces the first air inlet 111 so that the airflow may enter the airflow generating element 12 along the inclined side wall.

In some more specific embodiments, the first air inlet 111 is annular. On any plane perpendicular to the airflow direction of the primary airflow channel A, the projection of the first vent 171, the first air inlet 111, and the second vent 172 forms a circle or annular shape nested in sequence from small to large.

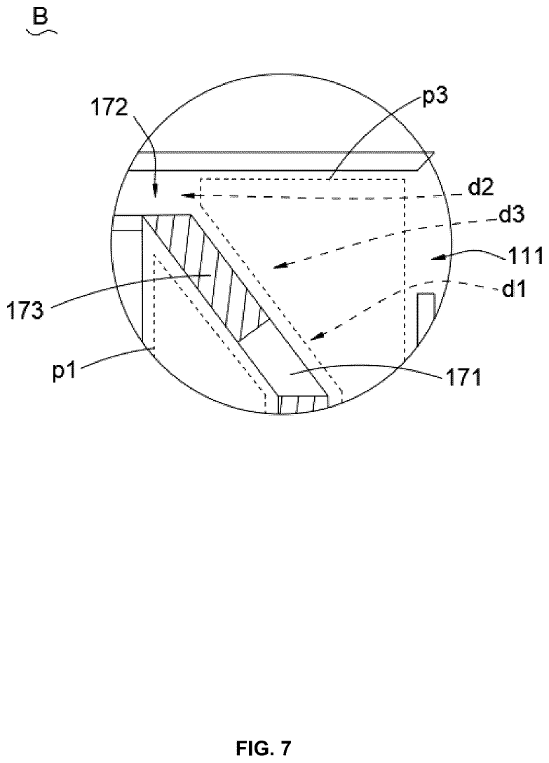

Referring to FIG. 6 and FIG. 7, the airflow entering the first air inlet 111 along the axis direction may be roughly divided into airflow D1, airflow D2 and airflow D3.

The airflow D3 passes through the middle area of the first air inlet 111, directly flows into the air guide 173, and is directed to the first vent 171 or the second vent 172 on the air guide 173. Because the airflow D3 does not pass directly through the edge of the first air inlet 111, the overall airflow resistance is small, and it is the main part of all the airflow passing through the first air inlet 111.

For the airflow D1, because the projection shape of the first air inlet 111 is larger than that of the first vent 171 and is sleeved on the outer edge of the first vent 171, the airflow D1 may not directly pass through the first air inlet 111 along the axis in a straight path and enters the first vent 171. The reason is that, since the first vent 171 communicates with the first region P1 with the highest negative pressure, if the first vent 171 forms a straight path with the air from the external environment, the airflow will be caused to flow through the edge of the first air inlet 111 at a very high speed, causing large airflow noise. In the embodiment shown in FIG. 7, the edge of the first air inlet 111 covers the first vent 171 in the axis direction, so that the airflow D1 flows in a curved path, thereby reducing the airflow noise when the airflow D1 passes through the edge of the first air inlet 111. It shall be noted that there is no actual boundary between airflow D1 and airflow D3, and according to the above, both airflow D1 and airflow D3 are designed to slow down the airflow speed and thus reduce the airflow noise as the airflow passes through the first air inlet 111.

The negative pressure in the second region P2 is smaller than that in the first region P1. On the one hand, the speed of the airflow entering the second vent 172 is smaller without considering the airflow noise. On the other hand, the airflow rate of the second vent 172 needs to be increased as much as possible to meet the heat dissipation needs of the radiation element 13. The radial size of the first air inlet 111, as a result, is designed to be smaller than that of the second vent 172, so that the airflow D2 may directly pass through the first air inlet 111 and enter the second vent 172 along a straight path.

As shown in FIG. 4, in some specific embodiments, the drying apparatus 10 further comprises a baffle 113 coupled to the housing 11 and/or the airflow guide 17. An annular first air inlet 111 is configured between the edge of the baffle 113 and the housing 11 to adapt to the aforesaid annular first vent 171 and the second vent 172 to realize a uniform air intake. The edge of the baffle 113 may be further designed in a shape of an arc, a slope, etc., to reduce airflow noise.

As shown in FIG. 5, in some embodiments, the drying apparatus 10 comprises a first heating element 161 and a second heating element 162. The airflow entering the housing 11 via the second air inlet 112 dissipates heat at least partially with the first heating element 161. The airflow in the primary airflow channel A dissipates heat with the second heating element 162.

The heat generated by the second heating element 162, the radiation element 13 and the first heating element 161 decreases sequentially, and the airflow required for heat dissipation of the three also decreases sequentially. Therefore, in the drying apparatus 10, the three airflow channels with sequentially decreasing airflow rate are configured to dissipate heat of these three structures respectively. On the premise that the heat dissipation needs of each structure may be satisfied, the influence of airflow noise, airflow speed and airflow smoothness of the corresponding airflow is minimized. Specifically:

The airflow rate of the primary airflow channel A is the largest, corresponding to the second heating element 162 with the largest heat generation capacity. The airflow rate of the auxiliary airflow channel B is medium, corresponding to the radiation element 13 with medium heat generation capacity. The airflow entering the housing 11 via the second air inlet 112 is part of the airflow in the auxiliary airflow channel B, so the airflow rate of this part is the smallest, and the first heating element 161 has the smallest heat generation capacity.

Referring to FIG. 2, in some embodiments, the airflow of the primary airflow channel A passes through at least part of the radiation element 13 while exchanging heat with the radiation element 13. For example, when the heat generation of the radiation element 13 is large and the airflow of the auxiliary airflow channel B is insufficient to dissipate heat, heat generated by the radiation element 13 is dissipated by the airflow of the primary airflow channel A to keep it within a suitable temperature range. In addition, when the second heating element 162 is operating, the heat emitted by itself may heat the radiation element 13. The airflow in the primary airflow channel A may simultaneously absorb the heat of the second heating element 162 and the radiation element 13, so that the temperature of the airflow is increased on the one hand, and the radiation element 13 may avoid absorbing heat from the second heating element 162 on the other hand.

In some other embodiments not shown, the airflow of the primary airflow channel A does not pass directly through the radiation element 13, instead, the primary airflow channel A is isolated from the radiation element 13 to mitigate the airflow resistance and airflow noise caused by the airflow of the primary airflow channel A passing through the radiation element 13. Furthermore, the structure that isolates the primary airflow channel A from the radiation element 13 may have a high thermal conductivity so that the airflow in the primary airflow channel A may still exchange heat with the radiation element 13 to realize the aforesaid heat dissipation of the radiation element 13. The radiation element 13, as a result, may avoid being heated by the second heating element 162. In addition, the structure isolating the primary airflow channel A from the radiation element 13 may have a lower thermal conductivity so that the airflow in the primary airflow channel A does not exchange heat with the radiation element 13. The airflow in the primary airflow channel A, as a result, may avoid reheating the eradiation element 13 after from being heated by the second heating element 162. In some embodiments, the auxiliary airflow channel B may already have kept the radiation element 13 within a suitable temperature range. Because the airflow of the primary airflow channel A has larger airflow rate and higher airflow speed, if the primary airflow channel A exchanges heat with the radiation element 13, the radiation element 13 may be lower than its suitable temperature range. Such problem may be avoided by isolating the radiation element 13 from the primary airflow channel A with a structure of lower thermal conductivity.

As shown in FIG. 2, in some more specific embodiments, the housing 11 comprises the first sub airflow channel C1 and the second sub airflow channel C2. An upstream of the first sub airflow channel C1 and the second sub airflow channel C2 all communicates with the second air inlet 112. The airflow in the first sub airflow channel C1 merges into the auxiliary airflow channel B to dissipate heat of the radiation element 13, and then merges into the primary airflow channel A to dissipate heat of the second heating element 162. After the airflow in the second sub airflow channel C2 dissipates heat with the first heating element 161, it then merges into the primary airflow channel A to dissipate heat of the second heating element 162.

According to the first law of thermodynamics, after the airflow of the first sub airflow channel C1 passes through the first heating element 161, its temperature must be less than that of the first heating element 161, which may still subsequently be able to dissipate the heat of the radiation element 13. In the same way, the airflow passing through the radiation element 13 is also cooler than that of the radiation element 13, which may still be able to dissipate the heat of the second heating element 162 subsequently.

For relevant description of the first sub airflow channel C1 and the second sub airflow channel C2, please refer to contents of the other part of this disclosure.

In some more specific embodiments, the second heating element 162 may be a resistance wire, a ceramic heating element, or other structures. Its main function is to convert the electric current into heat energy, thereby heating the airflow formed inside the drying apparatus 10, so that the drying apparatus 10 may emit a hot airflow to accelerate the evaporation of water. In other words, the purpose of heat exchange when the airflow passes through the first heating element 161 and the radiation element 13 is to dissipate heat to reduce the temperature of the first heating element 161 and the radiation element 13, and the purpose of heat exchange when the airflow passes through the second heating element 162 is to absorb heat to increase the temperature of the airflow itself.

It may be seen from the foregoing that among all the airflows merging into the primary airflow channel A, there is one part of the airflow that is heated by the first heating element 161 and another part of the airflow that is heated by the radiation element 13, which is equivalent to preheating the airflow of the primary airflow channel A with the help of the first heating element 161 and the radiation element 13. Based on this, the second heating element 162 consumes less energy to heat the airflow of the primary airflow channel A to a preset temperature. In other words, under the premise of the same energy consumption, the second heating element 162 may heat the airflow of the primary airflow channel A to a higher temperature. In addition, in some embodiments, the second heating element 162 itself may be switched on or off, corresponding to HOT mode and COOL mode of the drying apparatus 10 respectively. In the COOL mode of the drying apparatus 10, the first heating element 161 and the radiation element 13 may also slightly increase the temperature of the airflow to prevent the user from feeling a cold airflow.

In some embodiments shown in FIG. 1, when the drying apparatus 10 is operating, the flow path along which the airflow passes via the first air inlet 111 to the primary airflow channel A is less than the flow path via the second air inlet 112 to the primary airflow channel A; and/or the overall airflow resistance via the first air inlet 111 to the primary airflow channel A is smaller than that via the second air inlet 112 to the primary airflow channel A. In this way, the airflow rate entering via the first air inlet 111 is larger, forming the primary airflow in the primary airflow channel A, and the airflow flow entering via the second air inlet 112 is smaller, forming the secondary airflow in the primary airflow channel A.

In some more specific embodiments, a first filter (not shown) is detachably coupled at the first air inlet 111, and a second filter (not shown) is detachably coupled at the second air inlet 112.

The first filter and the second filter respectively filter the airflow entering the housing 11. When using the drying apparatus 10, dust, hair, or others may accumulate at any one of the first filter and the second filter, resulting in different degrees of blockage. Even if the user fails to clean one of the first filter and the second filter in time when either one is blocked, according to the foregoing disclosure, the drying apparatus 10 may still have sufficient airflow to dissipate heat of the radiation element 13.

In the description of this specification, references to the terms “one embodiment”, “some embodiments”, “schematic embodiments”, “examples”, “specific examples” or “some examples”, etc., are intended to mean that the specific features, structures, materials or features described in conjunction with the embodiments or examples are contained in at least one embodiment or example of the present disclosure. In this specification, indicative representations of the above terms do not necessarily refer to the same embodiments or examples. Further, the specific features, structures, materials, or features described may be combined in an appropriate manner in any one or more embodiments or examples. In addition, without contradicting each other, those skilled in the art may combine and combine the different embodiments or examples described in this specification and the features of the different embodiments or examples.

Notwithstanding that embodiments of the present disclosure have been shown and described, it may be understood by a person of ordinary skill in the art that a variety of variations, modifications, substitutions and variants may be made to these embodiments without departing from the principle and purpose of the present disclosure, and the scope of the present disclosure is limited by the claims and their equivalents.

1. A drying apparatus, the drying apparatus comprising:
a housing;
an airflow generating element in a primary airflow channel configured to generate an airflow; and
a radiation element, at least partially within an auxiliary airflow channel, configured to generate infrared radiation; wherein
the housing comprises a first air inlet, a second air inlet and an air outlet that are independent of each other,
an upstream of the primary airflow channel communicates with the first air inlet, and its downstream communicates with the air outlet; and
an upstream of the auxiliary airflow channel communicates with the first air inlet and the second air inlet, and its downstream communicates with the primary airflow channel.

2. The drying apparatus of claim 1, wherein the housing comprises:
a main body comprising the air outlet and the first air inlet, and the primary airflow channel And at least part of the auxiliary airflow channel are within the main body; and
a handle, coupled to the main body, configured with the second air inlet.

3. The drying apparatus of claim 2, wherein the handle is configured with:
a first sub airflow channel, wherein an upstream of the first sub airflow channel communicates with the second air inlet, and a downstream of the first sub airflow channel communicates with the upstream of the auxiliary airflow channel;
a second sub airflow channel, wherein an upstream of the second sub airflow channel communicates with the second air inlet, and a downstream of the second sub airflow channel communicates with the upstream of the primary airflow channel; and
a first heating element, at least partially within the second sub airflow channel.

4. The drying apparatus of claim 3, wherein it further comprises
a substrate, wherein at least part of the substrate is within the handle, the first sub airflow channel and the second sub airflow channel are respectively configured on two sides of the substrate, and
a plurality of electronic components configured on one side of the substrate facing the second sub airflow channel, and constituting the first heating element.

5. The drying apparatus of claim 4, wherein a plane where the substrate is located is perpendicular to an airflow direction of the primary airflow channel.

6. The drying apparatus of claim 4, wherein a portion of the substrate is within the handle, and the other parts extend into the main body.

7. (canceled)

8. The drying apparatus of claim 1, further comprising
an airflow guide configured inside the first air inlet, and constituting at least part of a first vent and at least part of a second vent; wherein
the upstream of the primary airflow channel communicates with the first air inlet via the first vent, and the upstream of the auxiliary airflow channel communicates with the first air inlet via the second vent.

9. The drying apparatus of claim 8, wherein negative pressure is formed within a plurality of areas in the housing and is sequentially when the airflow generating element operates, where the pluralities of areas comprise:
a first area, configured between the airflow guide and the airflow generating element;
a second area, configured adjacent to the radiation element;
a third area, configured adjacent and coupled to the first air inlet; and
a fourth area, configured adjacent and coupled to the second air inlet;
wherein the second area communicates with the first area and the fourth area respectively,
the first area communicates with the third area via the first vent, and
the second area communicates with the third area via the second vent.

10. The drying apparatus of claim 9, wherein the housing is configured with an air guiding sleeve, the airflow generating element is configured inside the air guiding sleeve;
a first gap airflow channel configured for the airflow to pass through is formed between the airflow generating element and the air guiding sleeve, and the first area communicates with the second area via the first gap airflow channel; and
a second gap airflow channel configured for the airflow to pass through is formed between the air guiding sleeve and the housing, the second area communicates with the second gap airflow channel, which communicates with the third area via the second vent and with the fourth area.

11. The drying apparatus of claim 10, wherein one end of the air guiding sleeve is mutually coupled to the airflow guide and forms a seal, which isolates the first gap airflow channel and the second gap airflow channel;
the other end of the air guiding sleeve is coupled to the radiation element to form at least part of the second area at the coupling place, and the first gap airflow channel communicates with the second gap airflow channel via the second area.

12-14. (canceled)

15. The drying apparatus of claim 8, wherein a gap between an outer edge of the airflow guide and the housing constitutes the second vent.

16. The drying apparatus of claim 8, wherein the second vent is configured around the outside of the first vent; the first vent is circular or annular, and has a geometric center coinciding with the second vent that is annular.

17. (canceled)

18. The drying apparatus according to claim 8, wherein the airflow guide is also configured with an air guide connecting the first vent and the second vent;
the first vent, the air guide, and the second vent are all annular and nested in sequence;
the air guide is inclined to the airflow direction of the primary airflow channel; and
the airflow guide comprises an inclined side wall configured inclined relative to the airflow direction of the primary airflow channel, and the air guide and the first vent are configured on the inclined side wall.

19-21. (canceled)

22. The drying apparatus of claim 8, wherein the first vent comprises a plurality of ventilation holes, the axis of at least part of the ventilation holes is inclined to the airflow direction of the primary airflow channel;
the plurality of ventilation holes are annularly distributed, and the axes of at least part of the ventilation holes intersect at the airflow generating element.

23. (canceled)

24. The drying apparatus of claim 22, wherein the first vent comprises a grid comprises a plurality of supporting strips extending radially and/or circumferentially along the airflow guide, each having an inclined surface with low airflow resistance in a direction facing the first air inlet, and the plurality of supporting strips encloses to form the plurality of ventilation holes.

25. The drying apparatus of claim 9, wherein the airflow guide protrudes in the middle of a direction away from the airflow generating element, and comprises a recess located towards the airflow generating element, and the recess constitutes at least a partial boundary of the first area.

26. (canceled)

27. (canceled)

28. The drying apparatus of claim 8, wherein it further comprises a baffle coupled to the housing and/or the airflow guide, and the first air inlet is configured annularly between the edge of the baffle and the housing.

29. The drying apparatus of claim 1, wherein it further comprises:
a first heating element, which heat is dissipated by at least part of the airflow entering the housing via the second air inlet; and
a second heating element, which heat is dissipated by the airflow in the primary airflow channel;
wherein the heat generated by the second heating element, the radiation element, and the first heating element decreases sequentially during operation.

30. The drying apparatus of claim 29, wherein the housing is further configured with a first sub airflow channel and a second sub airflow channel, and all upstream of the first sub airflow channel and the second sub airflow channel communicates with the second air inlet;
after the airflow in the first sub airflow channel merges into the auxiliary airflow channel and dissipate heat of the radiation element, it then merges into the primary airflow channel and dissipate heat of the second heating element;
after the airflow in the second sub airflow channel dissipates heat of the first heating element, it is then merged into the primary airflow channel and dissipates heat of the second heating element.

31. The drying apparatus of claim 1, wherein the flow path via the first air inlet to the primary airflow channel is smaller than the flow path via the second air inlet to the primary airflow channel, and/or the overall airflow resistance via the first air inlet to the primary airflow channel is less than that via the second air inlet to the primary airflow channel.

32. (canceled)
